(19) United States
(12) Patent Application Publication
(10) Pub. No.: US 2024/0365117 A1
(43) Pub. Date: Oct. 31, 2024

(54) APPARATUS, METHODS, AND COMPUTER PROGRAMS

(71) Applicant: Nokia Technologies Oy, Espoo (FI)

(72) Inventors: Maryse Gardella, Velizy-Villacoublay (FR); Gerald Gormer, Wandlitz (DE)

(21) Appl. No.: 18/683,085

(22) PCT Filed: Aug. 13, 2021
(86) PCT No.: PCT/EP2021/072652

§ 371 Date: Feb. 12, 2024

(51) Int. Cl. H04W 12/06; H04L 9/40; H04W 4/24

(52) U.S. Cl. CPC H04W 12/06; H04L 63/0892; H04W 4/24

(57) ABSTRACT

There is disclosed an apparatus caused to perform: during or subsequent to performing at least part of an authentication and/or authorisation procedure for a user equipment to access a network slice: signalling. to a charging function, a charging data request, the charging data request comprising an identifier of the user equipment, an identifier of the network slice. and an indication of an event to which the charging data request relates; and receiving, from the charging function, a charging data response.

### FIELD

The present disclosure relates to apparatus, methods, and computer programs, and in particular but not exclusively to apparatus, methods and computer programs for network apparatuses.

### BACKGROUND

A communication system can be seen as a facility that enables communication sessions between two or more entities such as user terminals, access nodes and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known is the long-term evolution (LTE) or the Universal Mobile Telecommunications System (UMTS) radio-access technology. Another example communication system is so called 5G system that allows user equipment (UE) or user device to contact a 5G core via e.g. new radio (NR) access technology or via other access technology such as Untrusted access to 5GC or wireline access technology.

### SUMMARY

According to a first aspect, there is provided an apparatus for a network function, the apparatus comprising means for: during or subsequent to performing at least part of an authentication and/or authorisation procedure for a user equipment to access a network slice: signalling, to a charging function, a charging data request, the charging data request comprising an identifier of the user equipment, an identifier of the network slice, and an indication of an event to which the charging data request relates; and receiving, from the charging function, a charging data response.

The network function may be a network slice specific authentication and authorization function.

The network function may be an access and mobility function.

The apparatus may comprise means for receiving, from an Authentication, Authorization and Accounting server, a charging profile for a Network Slice-Specific Authentication and Authorization process.

When the network function is an access and mobility function, the means for receiving the charging profile may comprise means for receiving the charging profile via a Network Slice-Specific Authentication and Authorization function.

The charging profile may comprise a set of charging characteristics, and the apparatus comprises means for: storing a set of charging characteristics; and overriding use of the stored set of charging characteristics to use the charging characteristics comprised in the charging profile.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The event may be one of: an authorization, a reauthorization, an authentication, a reauthentication, and/or a revocation.

The apparatus may comprise means for determining whether charging for Network Slice-Specific Authentication and Authorization is active in the apparatus, wherein said signalling is performed when it is determined that charging for Network Slice-Specific Authentication and Authorization is active in the apparatus.

The charging data response may comprise an indication of the event.

The charging data request may indicate whether the event has been successful or unsuccessful.

According to a second aspect, there is provided an apparatus for an Authentication, Authorization and Accounting function, the apparatus comprising means for: sending, to a network function, a charging profile for a network slice specific Authentication and Authorization process.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The charging data response may comprise an indication of the event.

The charging data request may indicate whether the event has been successful or unsuccessful.

According to a third aspect, there is provided an apparatus for a charging function, the apparatus comprising means for: receiving, from a network function, a charging data request, the charging data request comprising an identifier of a user equipment, an identifier of a network slice, and an indication of an event to which the charging data request relates, wherein the event is one of: an authorization, a reauthorization, an authentication, a reauthentication, and/or a revocation; and signalling, to the network function, a charging data response.

The apparatus may comprise means for creating a charging record in response to receipt of the charging data request.

The charging data response may comprise an indication of the event.

The charging data request may indicate whether the event has been successful or unsuccessful.

According to a fourth aspect, there is provided an apparatus for a network function, the apparatus comprising: at least one processor; and at least one memory comprising code that, when executed by the at least one processor, causes the apparatus to: during or subsequent to performing at least part of an authentication and/or authorization procedure for a user equipment to access a network slice: signal, to a charging function, a charging data request, the charging data request comprising an identifier of the user equipment, an identifier of the network slice, and an indication of an event to which the charging data request relates; and receiving, from the charging function, a charging data response.

The network function may be a network slice specific authentication and authorization function.

The network function may be an access and mobility function.

The apparatus may comprise be caused to receive, from an Authentication, Authorization and Accounting server, a charging profile for a Network Slice-Specific Authentication and Authorization process.

When the network function is an access and mobility function, the receiving the charging profile may comprise receiving the charging profile via a Network Slice-Specific Authentication and Authorization function.

The charging profile may comprise a set of charging characteristics, and the apparatus may be caused to: store a set of charging characteristics; and override use of the stored set of charging characteristics to use the charging characteristics comprised in the charging profile.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The event may be one of: an authorization, a reauthorization, an authentication, a reauthentication, and/or a revocation.

The apparatus may be caused to determine whether charging for Network Slice-Specific Authentication and Authorization is active in the apparatus, wherein said signalling is performed when it is determined that charging for Network Slice-Specific Authentication and Authorization is active in the apparatus.

The charging data response may comprise an indication of the event.

The charging data request may indicate whether the event has been successful or unsuccessful.

According to a fifth aspect, there is provided an apparatus for an Authentication, Authorization and Accounting function, the apparatus comprising: at least one processor; and at least one memory comprising code that, when executed by the at least one processor, causes the apparatus to: send, to a network function, a charging profile for a network slice specific Authentication and Authorization process.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The charging data response may comprise an indication of the event.

The charging data request may indicate whether the event has been successful or unsuccessful.

According to a sixth aspect, there is provided an apparatus for a charging function, the apparatus comprising: at least one processor; and at least one memory comprising code that, when executed by the at least one processor, causes the apparatus to: receive, from a network function, a charging data request, the charging data request comprising an identifier of a user equipment, an identifier of a network slice, and an indication of an event to which the charging data request relates, wherein the event is one of: an authorization, a reauthorization, an authentication, a reauthentication, and/or a revocation; and signal, to the network function, a charging data response.

The apparatus may be caused to create a charging record in response to receipt of the charging data request.

The charging data response may comprise an indication of the event.

The charging data request may indicate whether the event has been successful or unsuccessful.

According to a seventh aspect, there is provided a method for an apparatus for a network function, the method comprising: during or subsequent to performing at least part of an authentication and/or authorization procedure for a user equipment to access a network slice: signalling, to a charging function, a charging data request, the charging data request comprising an identifier of the user equipment, an identifier of the network slice, and an indication of an event to which the charging data request relates; and receiving, from the charging function, a charging data response.

The network function may be a network slice specific authentication and authorization function.

The network function may be an access and mobility function.

The method may comprise receiving, from an Authentication, Authorization and Accounting server, a charging profile for a Network Slice-Specific Authentication and Authorization process.

When the network function is an access and mobility function, the receiving the charging profile may comprise receiving the charging profile via a Network Slice-Specific Authentication and Authorization function.

The charging profile may comprise a set of charging characteristics, and the method may comprise: storing a set of charging characteristics; and overriding use of the stored set of charging characteristics to use the charging characteristics comprised in the charging profile.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The event may be one of: an authorization, a reauthorization, an authentication, a reauthentication, and/or a revocation.

The method may comprise determining whether charging for Network Slice-Specific Authentication and Authorization is active in the apparatus, wherein said signalling is performed when it is determined that charging for Network Slice-Specific Authentication and Authorization is active in the apparatus.

The charging data response may comprise an indication of the event.

The charging data request may indicate whether the event has been successful or unsuccessful.

According to an eighth aspect, there is provided a method for an apparatus for an Authentication, Authorization and Accounting function, the method comprising: sending, to a network function, a charging profile for a network slice specific Authentication and Authorization process.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The charging data response may comprise an indication of the event.

The charging data request may indicate whether the event has been successful or unsuccessful.

According to a ninth aspect, there is provided a method for an apparatus for a charging function, the method comprising: receiving, from a network function, a charging data request, the charging data request comprising an identifier of a user equipment, an identifier of a network slice, and an indication of an event to which the charging data request relates, wherein the event is one of: an authorization, a reauthorization, an authentication, a reauthentication, and/or a revocation; and signalling, to the network function, a charging data response.

The method may comprise creating a charging record in response to receipt of the charging data request.

The charging data response may comprise an indication of the event.

The charging data request may indicate whether the event has been successful or unsuccessful.

According to a tenth aspect, there is provided an apparatus for a network function, the apparatus comprising circuitry for: during or subsequent to performing at least part of an authentication and/or authorization procedure for a user equipment to access a network slice: signalling, to a charging function, a charging data request, the charging data request comprising an identifier of the user equipment, an identifier of the network slice, and an indication of an event to which the charging data request relates; and receiving, from the charging function, a charging data response.

The network function may be a network slice specific authentication and authorization function.

The network function may be an access and mobility function.

The apparatus may comprise receiving circuitry for receiving, from an Authentication, Authorization and Accounting server, a charging profile for a Network Slice-Specific Authentication and Authorization process.

When the network function is an access and mobility function, the circuitry for receiving the charging profile may comprise receiving circuitry for receiving the charging profile via a Network Slice-Specific Authentication and Authorization function.

The charging profile may comprise a set of charging characteristics, and the apparatus may comprise: storing circuitry for storing a set of charging characteristics; and overriding use of the stored set of charging characteristics to use the charging characteristics comprised in the charging profile.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The event may be one of: an authorization, a reauthorization, an authentication, a reauthentication, and/or a revocation.

The apparatus may comprise determining circuitry for determining whether charging for Network Slice-Specific Authentication and Authorization is active in the apparatus, wherein said signalling is performed when it is determined that charging for Network Slice-Specific Authentication and Authorization is active in the apparatus.

The charging data response may comprise an indication of the event.

The charging data request may indicate whether the event has been successful or unsuccessful.

According to an eleventh aspect, there is provided an apparatus for an Authentication, Authorization and Accounting function, the apparatus comprising: sending circuitry for sending, to a network function, a charging profile for a network slice specific Authentication and Authorization process.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The charging data response may comprise an indication of the event.

The charging data request may indicate whether the event has been successful or unsuccessful.

According to a twelfth aspect, there is provided an apparatus for a charging function, the apparatus comprising: receiving circuitry for receiving, from a network function, a charging data request, the charging data request comprising an identifier of a user equipment, an identifier of a network slice, and an indication of an event to which the charging data request relates, wherein the event is one of: an authorization, a reauthorization, an authentication, a reauthentication, and/or a revocation; and signalling circuitry for signalling, to the network function, a charging data response.

The apparatus may comprise creating circuitry for creating a charging record in response to receipt of the charging data request.

The charging data response may comprise an indication of the event.

The charging data request may indicate whether the event has been successful or unsuccessful.

According to a thirteenth aspect, there is provided non-transitory computer readable medium comprising program instructions for causing an apparatus for a network function to perform at least the following: during or subsequent to performing at least part of an authentication and/or authorization procedure for a user equipment to access a network slice: signal, to a charging function, a charging data request, the charging data request comprising an identifier of the user equipment, an identifier of the network slice, and an indication of an event to which the charging data request relates; and receiving, from the charging function, a charging data response.

The network function may be a network slice specific authentication and authorization function.

The network function may be an access and mobility function.

The apparatus may comprise be caused to receive, from an Authentication, Authorization and Accounting server, a charging profile for a Network Slice-Specific Authentication and Authorization process.

When the network function is an access and mobility function, the receiving the charging profile may comprise receiving the charging profile via a Network Slice-Specific Authentication and Authorization function.

The charging profile may comprise a set of charging characteristics, and the apparatus may be caused to: store a set of charging characteristics; and override use of the stored set of charging characteristics to use the charging characteristics comprised in the charging profile.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The event may be one of: an authorization, a reauthorization, an authentication, a reauthentication, and/or a revocation.

The apparatus may be caused to determine whether charging for Network Slice-Specific Authentication and Authorization is active in the apparatus, wherein said signalling is performed when it is determined that charging for Network Slice-Specific Authentication and Authorization is active in the apparatus.

The charging data response may comprise an indication of the event.

The charging data request may indicate whether the event has been successful or unsuccessful.

According to a fourteenth aspect, there is provided non-transitory computer readable medium comprising program instructions for causing an apparatus for an Authentication, Authorization and Accounting function to perform at least the following: send, to a network function, a charging profile for a network slice specific Authentication and Authorization process.

The charging profile may indicate whether charging for Network Slice-Specific Authentication and Authorization is active or inactive in the apparatus of the network function.

The charging profile may be comprised in an Authentication, Authorization and Accounting protocol message in response to an Authentication, Authorization and Accounting request.

The charging data response may comprise an indication of the event.

The charging data request may indicate whether the event has been successful or unsuccessful.

According to a fifteenth aspect, there is provided non-transitory computer readable medium comprising program instructions for causing an apparatus for a charging function to perform at least the following: receive, from a network function, a charging data request, the charging data request comprising an identifier of a user equipment, an identifier of a network slice, and an indication of an event to which the charging data request relates, wherein the event is one of: an authorization, a reauthorization, an authentication, a reauthentication, and/or a revocation; and signal, to the network function, a charging data response.

The apparatus may be caused to create a charging record in response to receipt of the charging data request.

The charging data response may comprise an indication of the event.

The charging data request may indicate whether the event has been successful or unsuccessful.

According to a sixteenth aspect, there is provided a computer program comprising program instructions for causing a computer to perform any method as described above.

According to a seventeenth aspect, there is provided a computer program product stored on a medium that may cause an apparatus to perform any method as described herein.

According to an eighteenth aspect, there is provided an electronic device that may comprise apparatus as described herein.

According to a nineteenth aspect, there is provided a chipset that may comprise an apparatus as described herein.

### BRIEF DESCRIPTION OF FIGURES

Examples will now be described, by way of example only, with reference to the accompanying Figures in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIGS. 6 to 8 shows example signalling as part of authentication and/or authorization procedures; and

FIGS. 9 to 11 are flow charts illustrating example operations performed by the apparatuses described herein.

### DETAILED DESCRIPTION

In the following, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems with analogous components (for example, current 6G proposals).

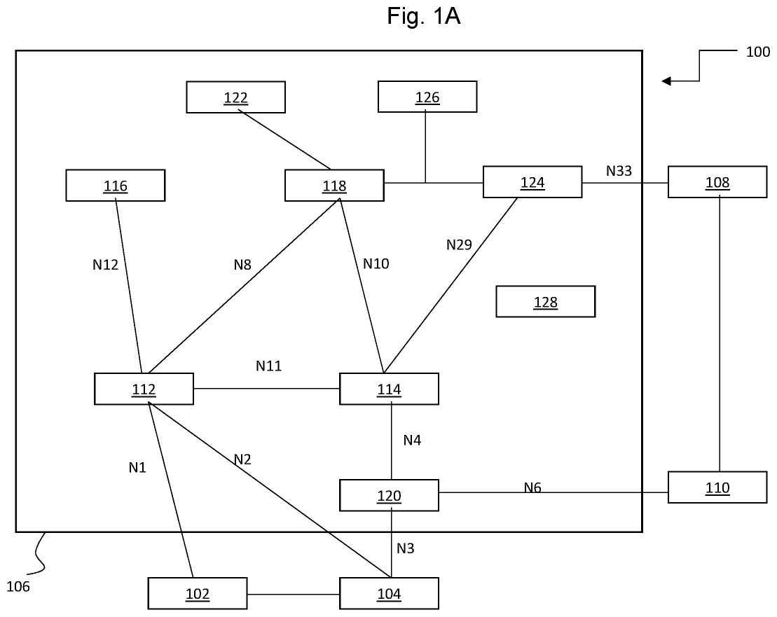

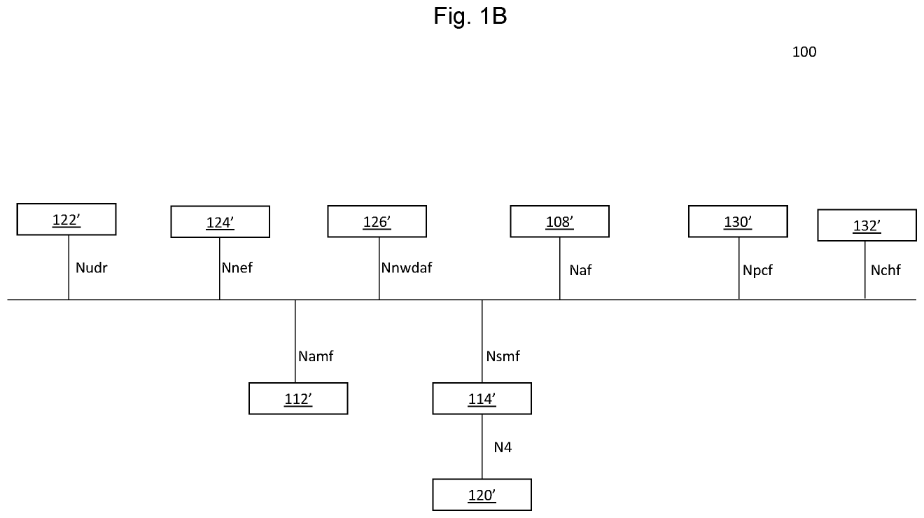

Before explaining in detail the exemplifying embodiments, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. Although NRF 128 is not depicted with its interfaces, it is understood that this is for clarity reasons and that NRF 128 may have a plurality of interfaces with other network functions.

The 5GC may also comprise a charging function (CHF) (not shown). This CHF performs online charging function and creates charging data records (CDR). CDRs are formatted collections of information about chargeable events for use in billing as well as accounting. Chargeable events may be any of a plurality of different things. For example, chargeable events may be at least one of time of call set-up, call duration, amount of data transferred, resource/service usage etc. Separate CDRs may be generated for each involved party to be charged for parts of or all charges of a chargeable event. Multiple CDRs may be generated for long transaction duration. A charging event refers to set of charging information forwarded by the Charging Trigger Function (CTF) towards the CHF or towards a charging data function (CDF) for offline charging. Each charging event matches exactly one chargeable event. The 5GC 106 also comprises a network data analytics function (NWDAF) 126.

FIG. 1B shows a schematic representation of a 5GC 106′ represented in current 3GPP specifications.

FIG. 1B shows a UPF 120′ connected to an SMF 114′ over an N4 interface. The SMF 114′ is connected to each of a UDR 122′, an NEF 124′, an NWDAF 126′, an AF 108′, a Policy Control Function (PCF) 130′, an AMF 112′, and a Charging function 132′ over an interconnect medium that also connects these network functions to each other.

3GPP refers to a group of organizations that develop and release different standardized communication protocols. 3GPP is currently developing and publishing documents related to Release 16, relating to 5G technology, with Release 17 currently being scheduled for 2022.

5G networks comprise the concept of network slicing, a concept that is likely to continue to be used in future 3GPP releases. Network slicing is the concept of creating multiple virtual networks on a common physical infrastructure that guarantee an agreed service level agreement (SLA) for specific functionality requested from different service providers or tenants. Each slice may provide complete network functionality, including radio access network functions, core network functions.

In more detail, network slicing overlays multiple virtual networks on top of a shared network. Each slice of the network can have its own logical topology, security rules and performance characteristics within the limits imposed by the underlying physical networks. A slice in a 3GPP network may be identified by its identifier within a public land mobile network (PLMN), this identifier being referred to herein as its Single Network Slice Selection Assistance Information (S-NSSAI). S-NSSAls are used by a UE in an access network in the PLMN that the SNSSAls are associated with in order to select at least one slice.

Network slicing can be useful as different slices can be dedicated to different purposes, such as ensuring a specific application or service gets priority access to capacity and delivery or isolating traffic for specific users or device classes. Slicing networks enables the network operator to maximize the use of network resources and service flexibility.

In addition to UE primary authentication, which is defined in 3GPP TS 33.501 chapter 16.2 and in which a UE may receive a list of Allowed S-NSSAI(s) the UE is to authorized to access (specified by 3GPP in Release 15), a Network Slice-Specific Authentication and Authorization (NSSAA) functionality has been introduced in Release 16. This NSSAA takes place between a UE and an Authentication, Authorization and Accounting (AAA) server (AAA-S) which can be owned by an external 3^{rd} party enterprise. AAA is used to refer to a family of protocols that mediate network access. It's understood in the below that although reference is made to an AAA-S, similar techniques may be applied to an AAA-Proxy (AAA-P).

Since the identifier for a slice (e.g. the S-NSSAI) is a part of the protocol data unit (PDU) session information used for context transfer, slice-aware admission control may be performed by the UE. If the UE is not registered for slice services, the UE may perform registration procedures, including authentication and authorization via an access and mobility function (AMF). The AMF mediates the UE access to an appropriate authorization and/or authentication entity, such as the Network Slice-Specific Authentication and Authorization function, which may in turn interact with a AAA server for authenticating and/or authorizing the UE.

3GPP TS 23.501 § 5.15.10 provides a high-level description of this NSSAA process.

In more detail, a serving PLMN is described as performing Network Slice-Specific Authentication and Authorization for the S-NSSAls of the home public land mobile network (HPLMN) that are subject to it, based on subscription information.

If the UE requests any of these S-NSSAIs that are subject to Network Slice-Specific Authentication and Authorization, those S-NSSAls are included in a list of “Pending NSSAI” for the PLMN to authenticate/authorise.

To perform Network Slice-Specific Authentication and Authorization for an S-NSSAI requested by the UE, in current 3GPP specifications, the AMF invokes an Extensible Authentication Protocol (EAP)-based Network Slice-Specific authorization procedure documented in 3GPP TS 23.502, clause 4.2.9. Using terminology in that the AMF may invoke an standard, as part of this operation, Nnssaaf_NSSAA_Authenticate Request to NSSAAF for an EAP-based Network Slice-Specific authorization procedure. In general, EAP-authentication and key agreement (AKA) is an authentication method supported in 5G. It is a challenge-and-response protocol based on a cryptographic key shared between a UE and its home network. It accomplishes the same level of security properties as 5G-AKA, e.g., mutual authentication between the UE and the network.

When the Network Slice-Specific Authentication and Authorization is completed for an S-NSSAI on the pending NSSAI list, the S-NSSAI becomes either part of the Allowed NSSAI or a Rejected S-NSSAI.

The following discusses mechanisms for enabling charging for Network Slice-Specific Authentication and Authorization transactions for a specific UE and a specific network slice. This charging does not have to relate to billing, and may be made for simply recording events/transactions that have occurred, such as for recording revocation events when authentication and/or authorization has been revoked as part of a revocation action.

In particular, the illustrates following, for a given network slice identifier (e.g. S-NSSAI) and per UE, the Network Slice-Specific Authentication and Authorization Function (NSSAAF) and/or AMF are configured to interact with the charging function (CHF) for charging data record (CDR) generation, during at least one of the following procedures:
Network Slice-Specific Authentication and Authorization to keep track of the transaction in Charging Data Request events and in CDRs.
Network Slice-Specific Re-authentication and Re-authorization to keep track of the transaction in Charging Data Request events and in CDRs.
Network Slice-Specific Authorization Revocation to keep track of the transaction in Charging Data Request events and in CDRs

A Charging Data Record (CDR) is a formatted collection of information about a chargeable telecommunication event (e.g. making a phone call, using the Internet from a user equipment, using network resource/service). CDRs are used for user or third party wholesale billing: a telecom provider transfers them (periodically and/or aperiodically) to the billing system in order to send bills to their users or third parties (e.g. enterprises).

In non-roaming scenarios, this CDR generation may also be performed in additional/alternate operations. For example, the CHF may generate a CDR from the NSSAAF only, from the AMF only, or from a combination of the AMF and the NSSAAF.

In roaming scenarios (such as when there is an interface between AMF and NSSAAF per TS 23.501, e.g. the N58 interface), then the CHF may generate CDRs from the NSSAAF in the HPLMN, and/or from an AMF in a visited PLMN for settlement with the HPLMN.

There may thus be provided/defined a new NSSAAF Charging profile that is used for charging activation/deactivation of authentication/authorization, re-authentication/re-authorization or revocation in the NSSAAF.

Further, there may be provided changes made to the existing AMF Charging profile currently defined in TS 32.256 chapter 5.2.1.2.2 in order to cover “NSSAA” in Post Event Charging (PEC) scenarios to introduce configuration for CDRs generation activation (and/or for Immediate Event Charging (IEC) charging scenarios, where applicable).

The following provides some examples of how the presently described techniques may be implemented.

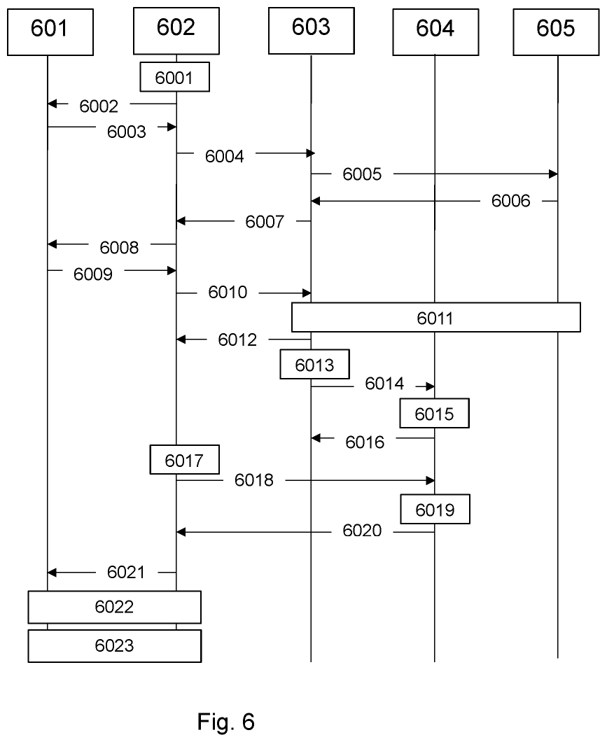

FIG. 6 is a signalling diagram illustrating different operations that may be performed by various elements described herein.

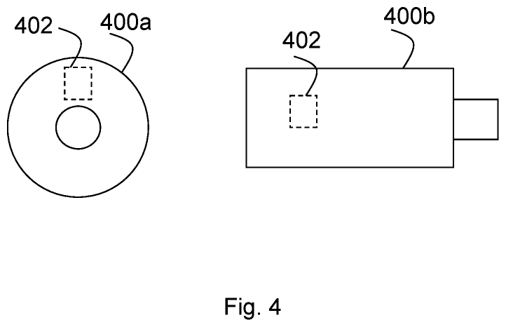

In the network of FIG. 6, the Network Slice-Specific Authentication and Authorization (NSSAA) procedure is triggered for an S-NSSAI requiring Network Slice-Specific Authentication and Authorization with an AAA Server (AAA-S), which may be hosted by the H-PLMN operator or by a third party. At least part of the operations shown in FIG. 6 correspond to operations described in relation to 3GPP TS 23.502 FIG. 4.2.9.2-1, which does not include interactions of a charging function, CHF.

FIG. 6 shows a UE 601, an AMF 602, an NSSAAF 603, a CHF 604, and AAA-S 605 (it is understood that the AAA-S may alternatively be an AAA-P). The NSSAAF 603 comprises an NSSAAF charging configuration. The NSSAAF charging configuration may be pre-configured by a management system in the network (e.g. by the Operation and Management (OAM) function).

Steps 6001 to 6004 relate to a Network Slice-Specific Authentication and Authorization (NSSAA) procedure being triggered from the AMF 602 towards NSSAAF 603 for a given slice (identified by, for example, the slice's S-NSSAI) for UE 601.

At 6001, the AMF 602 determines that a triggering event has occurred that means that a slice-specific authentication and authorization is to be performed.

At 6002, in response to this determination of 6001, the AMF 602 signals the UE 601. This signalling may indicate that an authentication is to be performed and comprise an identifier of the slice for which the authentication is to be performed. For example, the signalling may indicate that a user identification for EAP authentication is requested (e.g. the signalling may be an EAP ID Request), and comprise the S-NSSAI identifying the slice. This signalling may be transported using non-access stratum (NAS) signalling.

At 6003, the UE 601 responds to the signalling of 6002. The signalling of 6003 may indicate that the signalling of 6003 is a UE EAP ID response, and further comprise the S-NSSAI identifying the slice. This signalling may be transported using non-access stratum (NAS) signalling.

At 6004, the AMF 602 signals the NSSAAF 603. This signalling of 6004 may be a request for the NSSAAF to authenticate the user equipment 601 for the identified network slice. The signalling of 6004 may comprise the EAP ID response of 6003 (or a response for whatever protocol is being used to authenticate the UE 601). The signalling may comprise the S-NSSAI identifying the slice. The signalling may comprise a Generic Public Subscription Identifier (GPSI) for the subscriber of the UE 601. The GPSI may be, for example, at least one of a Mobile Station International ISDN (MSISDN) or an External Identifier.

Steps 6005 to 6006 relate to AAA protocol exchanges between the NSSAAF 603 and the AAA server (e.g. AAA-P (if any) and AAA-S) 605, using an EAP UE identity, GPSI and S-NSSAI with NSSAAF Charging profile potentially supplied by the AAA-S.

At 6005, the NSSAAF 603 signals the AAA server 605. This signalling relates to the AAA protocol. The signalling of 6005 may comprise the EAP ID response of 6004 (or a response for whatever protocol is being used to authenticate the UE 601). The signalling may comprise the S-NSSAI identifying the slice. The signalling may comprise the Generic Public Subscription Identifier (GPSI) for the subscriber of the UE 601.

At 6006, the AAA server 605 responds to the signalling of 6005. This signalling may comprise an EAP ID message (or a message for whatever protocol is being used to authenticate the UE 601). The signalling may comprise the S-NSSAI identifying the slice. The signalling may comprise the Generic Public Subscription Identifier (GPSI) for the subscriber of the UE 601. In addition, and new relative to existing procedures, this signalling may comprise an indication of the NSSAA charging profile to be used by a network function for the UE 601 when using NSSAA procedures for this slice. The network function may be, for instance, the AMF. The network function may be, for instance, the NSSAAF. This NSSAA charging profile may override any pre-configured NSSAAF Charging characteristics for the UE 601 using that slice. Before sending the NSSAA charging profile at 6006, the AAA server may first determine, based its local policies, that a dedicated NSSAA Charging profile for this UE (GPSI) and network slice (S-NSSAI) should be enforced. The NSSAA Charging profile may indicate that charging is active/inactive in the AMF and/or the NSSAAF for each of authentication/authorisation, re-authentication/re-authorisation, and/or revocation procedure.

Steps 6007 to 6013 relate to one or multiple iterations of EAP-messages exchange with the UE 601 being performed.

At 6007, the NSSAAF 603 sends an authentication response message to the AMF 602. This authentication response message may comprise, for example, the EAP message (or a message for whatever protocol is being used to authenticate the UE 601). The signalling may comprise the S-NSSAI identifying the slice. The signalling may comprise the Generic Public Subscription Identifier (GPSI) for the subscriber of the UE 601. This signalling may comprise the NSSAA Charging profile, which overrides any pre-configured AMF Charging characteristics for the UE 601 using that slice.

At 6008, the AMF 602 signals a transport message to the UE 601. This transport message may be signalled using NAS signalling. This transport message may comprise, for example, the EAP message (or a message for whatever protocol is being used to authenticate the UE 601). The signalling may comprise the S-NSSAI identifying the slice.

At 6009, the UE 601 signals a transport message to the AMF 602. This transport message may be signalled using NAS signalling. This transport message may comprise, for example, the EAP message (or a message for whatever protocol is being used to authenticate the UE 601). The signalling may comprise the S-NSSAI identifying the slice.

At 6010, the AMF signals an authentication request to the NSSAAF 603. This signalling of 6010 may be a request for the NSSAAF to authenticate the user equipment 601. The signalling of 6010 may comprise the EAP message of 6009 (or a response for whatever protocol is being used to authenticate the UE 601). The signalling may comprise the S-NSSAI identifying the slice. The signalling may comprise a Generic Public Subscription Identifier (GPSI) for the subscriber of the UE 601.

At 6011, the NSSAAF 603 may perform authentication with the AAA server 605. This authentication may use the EAP message of 6010, the S-NSSAI slice identification, and the GPSI provided in 6010.

The steps mentioned above with respect to the EAP message/signalling exchanged may be performed once, or a plurality or times.

At 6012, the NSSAAF 603 signals the result of the authentication of 6011 to the AMF 602. The result of this authentication may be that the authentication has been successful. The result of this authentication may be that the authentication has not be successful. The signalling comprising the result may also provide an indication of the UE and the slice to which the authentication result relates. For example, the signnaling of 6012 may comprise the S-NSSAI and the GPSI provided in 6010.

When the charging for NSSAA of this S-NSSAI is set to active in the NSSAAF, which is determined by the NSSAAF charging profile or by local configuration, then the Charging Data Request [Event] is sent to the charging function 604 by the NSSAAF 603 with the result of NSSAA Authentication (EAP-Success/Failure, S-NSSAI, GPSI) for NSSAAF charging data record generation. This is reflected in steps 6013 to 6016. At least steps 6013 to 6020 are not performed in currently known systems.

At 6013, the NSSAAF 603 determines that charging is active for the NSSAA authorization. The charging is determined to be active when it is determined that an interaction with the charging function is to be performed to create a CDR related to the authentication.

In response to this determination, at 6014 the NSSAAF 603 signals a charging data request to the charging function 604. This charging data request may comprise, for example, an indication of the chargeable event. The charging data request may comprise an identification of the user equipment. For example, the charging data request may comprise the GPSI of the user equipment. The charging data request may comprise an identification of the network slice. For example, the chargeable event may comprise NSSAA Authentication response (EAP-Success/Failure).

At 6015, the charging function 604 creates a charging data record based on received information in the request of 6014. The charging data record comprises at least some of the information provided in 6014. The charging data record may thus comprise at least one of the indication of the event, the identification of the slice, and the GPSI/identifier of the user equipment. The charging data record may comprise all of the indication of the event, the identification of the slice, and the GPSI/identifier of the user equipment.

At 6016, the charging function 604 responds to the charging data request of 6014. This charging data response may comprise the indication of successful charging data record creation or unsuccessful charging data record creation.

When the charging for the NSSAA is set to active in the extended AMF Charging profile, the Charging Data Request [Event] is sent to CHF by AMF with the result of NSSAA Authentication (EAP-Success/Failure, S-NSSAI, GPSI) for NSSAAF charging data function generation being indicated. This is reflected in steps 6017 to 6020.

At 6017, the AMF 602 determines that charging is active for the NSSAA Authorization in the AMF charging profile.

In response to this determination, at 6018 the AMF 602 signals a charging data request to the charging function 604. This charging data request may comprise, for example, an indication of the chargeable event. The charging data request may comprise an identification of the user equipment. For example, the charging data request may comprise the GPSI of the user equipment. The charging data request may comprise an identification of the network slice. For example, the chargeable event may comprise NSSAA Authentication response (EAP-Success/Failure).

At 6019, the charging function 604 creates a charging data record for the request of 6017. The charging data record comprises at least some of the information provided in 6017. The charging data record may thus comprise at least one of the indication of the event, the identification of the slice, and the GPSI/identifier of the user equipment. The charging data record may comprise all of the indication of the event, the identification of the slice, and the GPSI/identifier of the user equipment.

At 6020, the charging function 604 responds to the charging data request of 6018. This charging data response may comprise the indication of the event for which the charging data is being requested. This charging data response may comprise the indication of successful charging data record creation or unsuccessful charging data record creation.

At 6021, the AMF 602 signals the result of the authentication (e.g. EAP success or EAP failure) to the UE 601.

At 6022, the AMF 602 and the UE 601 interact to update the UEs configuration. This update may be, for example, an update to indicate the result of the authentication. For example, the configuration may be updated to indicate that the identified slice/S-NSSAI has been allowed. As another example, the configuration may be updated to indicate that the identified slice/S-NSSAI has been rejected.

At 6023, the AMF 602 and the UE 601 interact to deregister the UE. This deregistration may be initiated by the network.

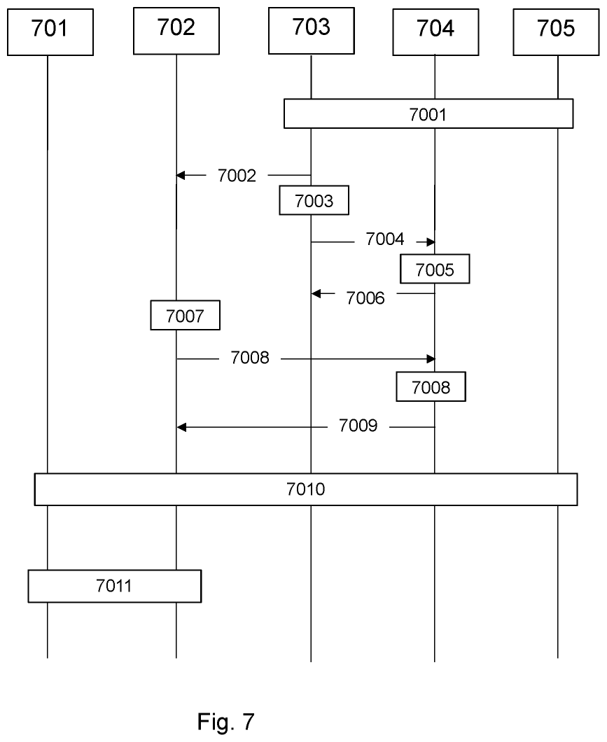

FIG. 7 illustrates a more detailed description of interaction with the charging function CHF for Network Slice-Specific Re-authentication and Re-authorization procedure triggered by AAA Server (utilizing terminology included in 3GPP TS 23.502 FIG. 4.2.9.3-1), and Slice-Specific Authorization Revocation (utilizing terminology based on TS 23.502 FIG. 4.2.9.4-1).

FIG. 7 shows signalling performed between a UE 701, an AMF 702, an NSSAAF 703, a charging function 704 and an AAA server 705. It is understood that the AAA server 705 may alternatively be an AAA-P.

At 7001, the NSSAAF 703, charging function 704 and the AAA server 605 perform network slice-specific reauthentication and reauthorization or revocation for a specific slice (identified by, for example, an S-NSSAI) and the UE 701 (identified by, for example, a GPSI). The reauthentication/reauthorization/revocation may be trigger by the AAA server towards the NSSAAF.

Assuming the AMF 702 is registered in a UDM, the NSSAAF 703 obtains an identifier for the AMF from UDM. This may be performed, for example, using the message Nudm_UECM_Get with the GPSI in the received AAA message.

Depending on whether reauthorization/reauthentication or revocation is being performed/requested, at 7002, the NSSAAF 703 notifies the AMF 702 that it intends to re-authenticate/re-authorize the S-NSSAI for the UE (using, for example, the Nnssaaf_NSSAA_Re-AuthNotification message with the GPSI and S-NSSAI), or that the NSSAAF will revoke the S-NSSAI authorization for the UE (using, for example, the Nnssaaf_NSSAA_RevocationNotification message).

Steps 7003 to 7006 relate to a situation when the NSSAAF determines that charging for the NSSAA is active in the NSSAAF 703.

At 7003, the NSSAAF 703 determines that charging for an NSSAA event of this S-NSSAI is set to active in the NSSAAF. This may be determined by the examining the NSSAAF charging profile, or by determining the local configuration. The event may be any of, for example, authentication, reauthentication, authorization, reauthorization, and/or revocation.

At 7004, the NSSAAF 703 signals a Charging Data Request [Event] to the charging function 704. The request may be, for example, a Re-Authentication Notification for NSSAAF charging data record generation. The request may be, for example, a Revocation Notification. This charging data request may comprise, for example, an indication of the chargeable event. The charging data request may comprise an identification of the user equipment. For example, the charging data request may comprise the GPSI of the user equipment. The charging data request may comprise an identification of the network slice. For example, the chargeable event may comprise NSSAA Authentication response (EAP-Success/Failure).

At 7005, the charging function 704 creates a charging data record for the event. The charging data record comprises at least some of the information provided in 7004. The charging data record may thus comprise at least one of the indication of the event, the identification of the slice, and the GPSI/identifier of the user equipment. The charging data record may comprise all of the indication of the event, the identification of the slice, and the GPSI/identifier of the user equipment.

At 7006, the charging function 705 response to the request of 7004. This charging data response may comprise the indication of the event for which the charging data is being requested. This charging data response may comprise the indication of successful charging data record creation or unsuccessful charging data record creation.

Steps 7007 to 7010 relate to a situation when the AMF 702 determines that charging for the NSSAA event is active in the AMF 702. As mentioned above, the event may be authentication, reauthentication, authorization, reauthorization, and/or revocation.

At 7007, the AMF 702 determines that charging for the NSSAA event is set to active in the AMF charging profile.

At 7008, the AMF 702 signals the charging function 705 with a charging data request. The charging data request may comprise an indication the event (e.g. revocation notification, re-authentication notification, etc.). The charging data request may comprise an indication of the identification of the slice (e.g. the S-NSSAI). This charging data request may comprise, for example, an indication of the chargeable event. The charging data request may comprise an identification of the user equipment. For example, the charging data request may comprise the GPSI of the user equipment. The charging data request may comprise an identification of the network slice. For example, the chargeable event may comprise NSSAA Authentication response (EAP-Success/Failure).

At 7009, the charging function 704 creates a charging data record for the event of 7008. The charging data record comprises at least some of the information provided in 7008. The charging data record may thus comprise at least one of the indication of the event, the identification of the slice, and the GPSI/identifier of the user equipment. The charging data record may comprise all of the indication of the event, the identification of the slice, and the GPSI/identifier of the user equipment.

At 7010, the charging function 705 responds to the request of 7008. This charging data response may comprise the indication of the event for which the charging data is being requested. This charging data response may comprise the indication of successful charging data record creation or unsuccessful charging data record creation.

At 7011, network slice-specific authentication and authorization is performed (if applicable).

At 7012, the UE configuration of the UE 701 is updated by signalling between the AMF 702 and the UE 701. This update may be, for example, an update to indicate the result of the authentication. For example, the configuration may be updated to indicate that the identified slice/S-NSSAI has been allowed. As another example, the configuration may be updated to indicate that the identified slice/S-NSSAI has been rejected.

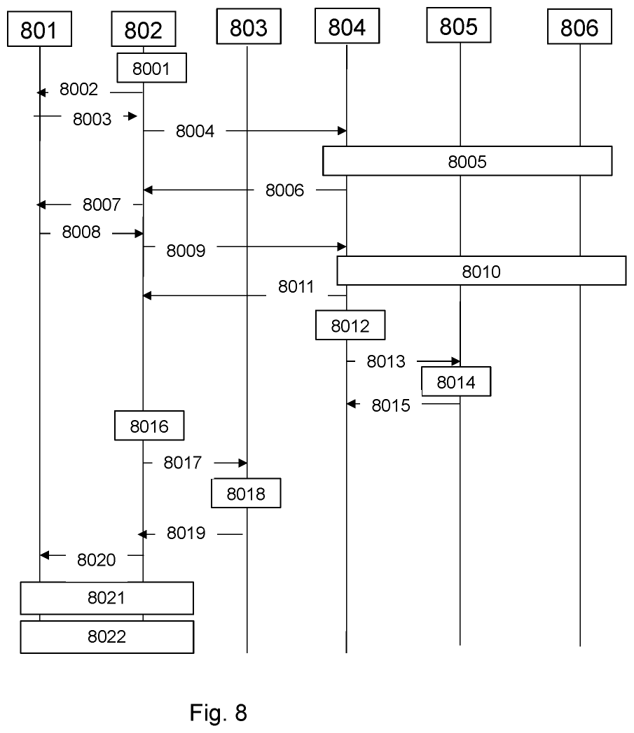

FIG. 8 illustrates operations that may be performed during a roaming scenario.

FIG. 8 shows operations that may be performed by a UE 801, an AMF 802, a first charging function 803, an NSSAAF 804, a second charging function 805 and an AAA server 806. The UE 801, AMF 802, and first charging function 803 are located in a VPLMN. The NSSAAF 804, second charging function 805, and AAA server 806 are located in the HPLMN. FIG. 8 utilizes language provided in TS 23.502 FIG. 4.2.9.2-1, but differs from this 3GPP description in that first and second charging functions are used each PLMN for reconciliation.

At 8001, the AMF 802 determines that a trigger has occurred to perform slice-specific authentication and authorization.

At 8002, the AMF 802 signals the UE 801 with an authentication and/or authorization request message. This signalling may be performed via NAS signalling. This signalling may be a transport message. This signalling may comprise a request for authentication and/or authorization. For example, this signalling may comprise an EAP ID request. The signalling of 8002 may comprise an identification of the specific slice. For example, the signalling of 8002 may comprise an S-NSSAI identifying the specific slice.

At 8003, the UE 801 responds to the signalling of 8002. This response may comprise a response value to the authentication and/or authorization request of 8002. This response may be performed via NAS signalling. This response may be a transport message. For example, this response may comprise an EAP ID response. The response of 8003 may comprise an identification of the specific slice. For example, the response of 8003 may comprise an S-NSSAI identifying the specific slice.

At 8004, the AMF 802 signals the NSSAAF 804. This signalling of 8004 may be a request for the NSSAAF to authenticate the user equipment 801. The signalling of 8004 may comprise the EAP ID response of 6003 (or a response for whatever protocol is being used to authenticate the UE 601). The signalling may comprise the S-NSSAI identifying the slice. The signalling may comprise a Generic Public Subscription Identifier (GPSI) for the subscriber of the UE 801.

Step 8005 relates to AAA protocol exchanges between the NSSAAF 803 and the AAA server (e.g. AAA-P (if any) and AAA-S) 805, using an EAP UE identity, GPSI and S-NSSAI with NSSAAF Charging profile potentially supplied by AAA-S

At 8005, the NSSAAF 804 signals the AAA server 605. This signalling relates to the AAA protocol. The signalling of 8004 may comprise the EAP ID response of 6004 (or a response for whatever protocol is being used to authenticate the UE 601). The signalling may comprise the S-NSSAI identifying the slice. The signalling may comprise the Generic Public Subscription Identifier (GPSI) for the subscriber of the UE 801. Further at 8005, the AAA server 805 responds to the signalling of the NSSAAF. This signalling may comprise an EAP ID message (or a message for whatever protocol is being used to authenticate the UE 801). The signalling may comprise the S-NSSAI identifying the slice. The signalling may comprise the Generic Public Subscription Identifier (GPSI) for the subscriber of the UE 601.

Steps 8006 to 8012 relate to one or multiple iterations of EAP-messages exchange with the UE 801 being performed.

At 8006, the NSSAAF 804 sends an authentication response message to the AMF 802. This authentication response message may comprise, for example, the EAP message (or a message for whatever protocol is being used to authenticate the UE 801). The signalling may comprise the S-NSSAI identifying the slice. The signalling may comprise the Generic Public Subscription Identifier (GPSI) for the subscriber of the UE 801.

At 8007, the AMF 802 signals a transport message to the UE 801. This transport message may be signalled using NAS signalling. This transport message may comprise, for example, the EAP message (or a message for whatever protocol is being used to authenticate the UE 801). The signalling may comprise the S-NSSAI identifying the slice.

At 8008, the UE 801 signals a transport message to the AMF 802. This transport message may be signalled using NAS signalling. This transport message may comprise, for example, the EAP message (or a message for whatever protocol is being used to authenticate the UE 801). The signalling may comprise the S-NSSAI identifying the slice.

At 8009, the AMF signals an authentication request to the NSSAAF 804. This signalling of 8009 may be a request for the NSSAAF to authenticate the user equipment 801. The signalling of 8009 may comprise the EAP message of 8008 (or a response for whatever protocol is being used to authenticate the UE 601). The signalling may comprise the S-NSSAI identifying the slice. The signalling may comprise a Generic Public Subscription Identifier (GPSI) for the subscriber of the UE 801.

At 8010, the NSSAAF 804 may perform authentication with the AAA server 806. This authentication may use the EAP message of 8010, the S-NSSAI slice identification, and the GPSI provided in 8009.

At 8011, the NSSAAF 804 signals the result of the authentication of 8010 to the AMF 802. The result of this authentication may be that the authentication has been successful. The result of this authentication may be that the authentication has not be successful. The signalling comprising the result may also provide an indication of the UE and the slice to which the authentication result relates. For example, the signalling of 8011 may comprise the S-NSSAI and the GPSI provided in 8009.

When the charging for NSSAA of this S-NSSAI is set to active in the NSSAAF, which may be determined by the NSSAAF charging profile or by local configuration, then the Charging Data Request [Event] is sent to the second charging function 805 by the NSSAAF 804 with the result of NSSAA Authentication (EAP-Success/Failure, S-NSSAI, GPSI) for NSSAAF charging data record generation. This is reflected in steps 8012 to 8015.

At least steps 8012 to 8019 are not performed in currently known systems.

At 8012, the NSSAAF 804 determines that charging is active for the NSSAA.

In response to this determination, at 8013 the NSSAAF 804 signals a charging data request to the charging function 604. This charging data request may comprise, for example, an indication of the event for which the charging data is being requested. The charging data request may comprise an identification of the slice for which the charging data is requested.

At 8014, the second charging function 805 creates a charging data record for the request of 8013.

At 8015, the second charging function 805 responds to the charging data request of 8013. This charging data response may comprise the indication of the event for which the charging data is being requested.

When the charging for the NSSAA is set to active in the extended AMF Charging profile, the Charging Data Request [Event] is sent to CHF by AMF with the result of NSSAA Authentication (EAP-Success/Failure, S-NSSAI, GPSI) for NSSAAF charging data function generation being indicated. This is reflected in steps 8016 to 8019.

At 8016, the AMF 802 determines that charging is active for the NSSAA in the AMF charging profile. Whether the charging is active may be pre-configured in the AMF 802. The pre-configuration may be performed by a management function. For example, the pre-configuration may be performed by an OAM function.

In response to this determination, at 8017 the AMF 802 signals a charging data request to the first charging function 803. This charging data request may comprise, for example, an indication of the event for which the charging data is being requested.

The charging data request may comprise an identification of the slice for which the charging data is requested.

At 8018, the first charging function 803 creates a charging data record for the request of 8017.

At 8019, the first charging function 803 responds to the charging data request of 8017. This charging data response may comprise the indication of the event for which the charging data is being requested.

At 8020, the AMF 802 signals the result of the authentication (e.g. EAP success or EAP failure) to the UE 801.

At 8021, the AMF 802 and the UE 801 interact to update the UEs configuration. This update may be, for example, an update to indicate the result of the authentication. For example, the configuration may be updated to indicate that the identified slice/S-NSSAI has been allowed. As another example, the configuration may be updated to indicate that the identified slice/S-NSSAI has been rejected.

At 8022, the AMF 802 and the UE 801 interact to deregister the UE. This deregistration may be initiated by the network. This is performed in the event that the event is unsuccessful.

NSSAAF has not previously been a consumer of CHF services.

Therefore, in the above, a New “NSSAAF Charging Information” Information Element is defined in the Charging Data Request message. This NSSAAF charging information may comprise an indication of the type of event it refers to (e.g. to authentication, re-authentication, and/or revocation). The NSSAAF charging information may comprise a GPSI for the user requesting slice access. The NSSAAF charging information may comprise an identifier for the slice being requested. The identifier may be, for example, an S-NSSAI.

The NSSAAF charging information may comprise at least one address of the AAA server to which the NSSAAF charging information is being sent. The NSSAAF charging information may comprise information on the results of the events being performed. For example, for authentication, the NSSAAF charging information may comprise an indication of a number of EAP (or equivalent) message exchanges, and/or an overall result of the EAP authentication procedure (e.g. success or failure). Similarly, an indication of an overall result may be provided for reauthentication and/or for revocation.

There is further provided a NSSAAF charging data record that comprises the NSSAAF charging information.

The currently defined AMF charging profile is also extended in the above example mechanisms in order to comprise an indication of NSSAA functionality. This extension may comprise, for example, an indication of whether charging is active or inactive. The AMF charging profile may also be extended to indicate when the charge is to be applied. For example, the AMF charging profile may indicate whether the charging is to be applied either post-event, or pre-event (e.g. Post Event Charging, IEC, ECUR, etc.).

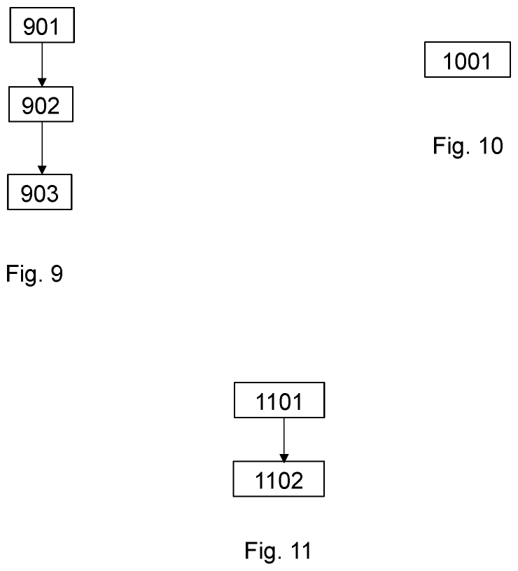

FIGS. 9 to 11 illustrate operations that may be performed by apparatus/entities mentioned herein. It is understood that these flowcharts illustrate some of the operations discussed in the above-provided examples of FIGS. 6 to 8, and that they are consequently not mutually exclusive. The apparatuses respectively performing the operations of of FIGS. 9 to 11 may interact with each other.

FIG. 9 relates to operations that may be performed by an apparatus for a network function. The network function may be, for example, an access and mobility function. The network function may be, for example, a network slice specific authentication and authorization function.

At 901, the apparatus determines to perform steps 902 and 903 during or subsequent to performing at least part of an authentication and/or authorization procedure for a user equipment to access a network slice.

At 902, the apparatus signals, to a charging function, a charging data request, the charging data request comprising an identifier of the user equipment, an identifier of the network slice, and an indication of an event to which the charging data request relates.

At 903, the apparatus receives, from the charging function, a charging data response. The charging data response may indicate whether the charging data record was successfully created or not. In other words, the charging data response may comprise at least one selectable bit whose value may vary to respectively indicate that the charging data record was successfully created and that the charging data record was not successfully created.

The event may be, for example, one of: an authorization, a reauthorization, an authentication, a reauthentication, and/or a revocation event. The event may be indicated by use of a particular type of message. For example, the event may be indicated using an NSSAAF Re-AuthenticationNotification when the event is a re-authentication. As another example, the event may be indicated using atNSSAAF RevocationNotification. (revocation) signal when the event is a revocation.

The indication for the event may indicate a type of event (e.g. an authorization, a reauthorization, an authentication, a reauthentication, and/or a revocation event). The indication for the event may be accompanied by, or otherwise comprise, an indication of a final result of the event. For example, the event may indicated using Authenticate Response (EAP-success/failure) signalling, which indicates both that the event is an authenticate response as well as the final result of that authentication procedure.

The apparatus may receive, from an Authentication, Authorization and Accounting server, a charging profile for a Network Slice-Specific Authentication and Authorization process. This receiving may be performed directly or indirectly. For example, when the network function is an access and mobility function, the apparatus may receive the charging profile via a Network Slice-Specific Authentication and Authorization function.

The charging profile may indicate whether charging for Network Slice-Specific Authentication and Authorization is active or inactive in the apparatus of the network function. The apparatus may determine whether charging for Network Slice-Specific Authentication and Authorization is active in the network function. Said signalling of 902 may be performed when it is determined that charging for Network Slice-Specific Authentication and Authorization is active in the apparatus. This determination may be performed using a charging profile configured in the network function/apparatus.

The charging profile may be comprised in an Authentication, Authorization and Accounting protocol message that is signalled to the network function in response to receipt of an Authentication, Authorization and Accounting request from the network function.

The charging profile may comprise a set of charging characteristics. In this case, the apparatus may be pre-configured with a set of charging characteristics that it stores. The pre-configuration may be performed by a management function, such as by an OAM. When the apparatus stores such pre-configured set of charging characteristics, the apparatus may override use of the stored set of charging characteristics to use the charging characteristics comprised in the charging profile instead.

FIG. 10 is a flow chart illustrating potential operations that may be performed by an apparatus for an Authentication, Authorization and Accounting (AAA) function. The AAA function may be a AAA-Server. The AAA function may be a AAA-Proxy. The AAA function may interact with the apparatus of FIG. 9.

At 1001, the apparatus sends, to a network function, a charging profile for a network slice specific Authentication and Authorization process.

The charging profile may indicate whether charging for Network Slice-Specific Authentication and Authorization is active or inactive in the apparatus of the network function.

The charging profile may be comprised in an Authentication, Authorization and Accounting protocol message that is signalled to the network function in response to receipt of an Authentication, Authorization and Accounting request from the network function. The Authentication, Authorization and Accounting request may comprise an identifier of a UE (e.g. the GPSI). The Authentication, Authorization and Accounting request may comprise an indication of the slice requested by the UE. The Authentication, Authorization and Accounting response may comprise an identifier of a UE (e.g. the GPSI). The Authentication, Authorization and Accounting response may comprise an indication of the slice requested by the UE.

FIG. 11 is a flow chart illustrating potential operations that may be performed by, for example, an apparatus for a charging function. The apparatus for the charging function may be configured to interact with the apparatus/network function of FIG. 9.

At 1101, the apparatus receives, from a network function (e.g. the network function of FIG. 9), a charging data request. The charging data request comprises an identifier of a user equipment, an identifier of a network slice, and an indication of an event to which the charging data request relates.

The event may be, for example, one of: an authorization, a reauthorization, an authentication, a reauthentication, and/or a revocation event. The event may be indicated by use of a particular type of message. For example, the event may be indicated using an NSSAAF Re-AuthenticationNotification when the event is a re-authentication. As another example, the event may be indicated using atNSSAAF RevocationNotification. (revocation) signal when the event is a revocation.

The indication for the event may indicate a type of event (e.g. an authorization, a reauthorization, an authentication, a reauthentication, and/or a revocation event). The indication for the event may be accompanied by, or otherwise comprise, an indication of a final result of the event. For example, the event may indicated using Authenticate Response (EAP-success/failure) signalling, which indicates both that the event is an authenticate response as well as the final result of that authentication procedure.

At 1102, the apparatus signals, to the network function, a charging data response. The charging data response may indicate whether the charging data record was successfully created or not. In other words, the charging data response may comprise at least one selectable bit whose value may vary to respectively indicate that the charging data record was successfully created and that the charging data record was not successfully created.

The apparatus may create a charging record in response to receipt of the charging data request. This charging record may be stored in the charging function. The charging function may pass the charging record to an entity for recordal and/or billing periodically or periodically.

The charging data response may comprise an indication of the event (e.g. an indication of type and/or an indication of a result of the event). Similarly, the charging data request may comprise an indication of the event (e.g. an indication of type and/or an indication of a result of the event).

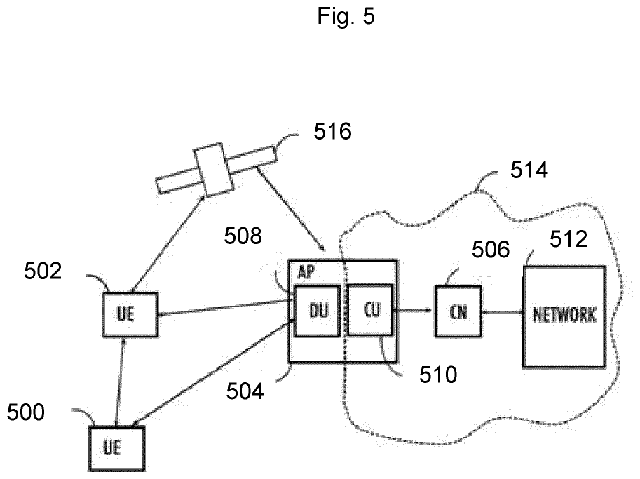

Although the examples provided above are described with respect to a Post Event Charging scenario, it is understood that the present disclosure is not limited to Post Event Charging. The presently described techniques may also be applied in other scenarios, such as, for example, Immediate Event Charging (IEC) and Event Charging with Unit Reservation (ECUR). Information on operations involving IEC and ECUR events are provided in, for example, 3GPP TS 32.290 (see FIG. 5.3.2.2.1 for IEC and FIG. 5.3.2.3.3 for ECUR). In such a case, the charging function may interact with the AMF and/or the NSSAAF prior to authentication messages for the UE and slice being exchanged with the AAA server.

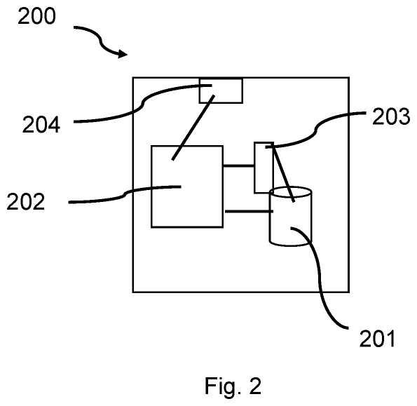

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR etc. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example the control apparatus 200 or processor 201 can be configured to execute an appropriate software code to provide the control functions.

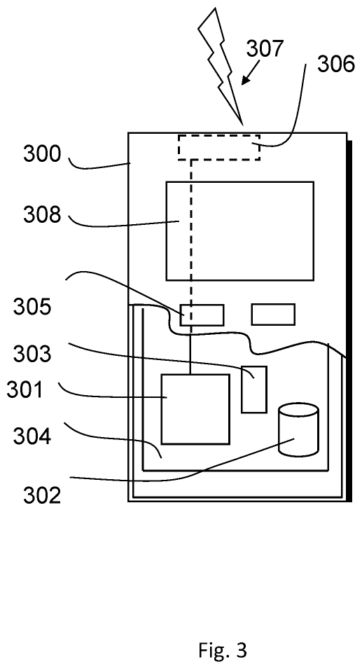

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 704. The user may control the operation of the wireless device by means of a suitable user interface such as key pad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 9, and/or FIG. 10, and/or FIG. 11.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 9, and/or FIG. 10, and/or FIG. 11, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

In the above, different examples are described using, as an example of an access architecture to which the presently described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g) NodeB serving devices in a cell. In one example, the node 504 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 506 (CN or next generation core NGC). Depending on the deployed technology, the (e/g) NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ-cmWave, 6 or above 24 GHz-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto-or picocells. The (e/g) NodeBs of FIG. 5 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H(e/g) nodeBs), a home node B gateway, or HNB-GW (not shown in FIG. 5). A HNB Gateway (HNB-GW), which is typically installed within an operator's network may aggregate traffic from a large number of HNBs back to a core network.

1-21. (canceled)

22. A method for a network function, the method comprising:
during or subsequent to performing at least part of an authentication and/or authorisation procedure for a user equipment to access a network slice:
signalling, to a charging function, a charging data request, the charging data request comprising an identifier of the user equipment, an identifier of the network slice, and an indication of an event to which the charging data request relates; and
receiving, from the charging function, a charging data response.

23. The method according to claim 22,
wherein the network function is a network slice specific authentication and authorization function.

24. The method according to claim 22,
wherein the network function is an access and mobility function.

25. The method as claimed in claim 24, comprising:
receiving, from an Authentication, Authorization and Accounting server, a charging profile for a Network Slice-Specific Authentication and Authorization process.

26. The method as claimed in claim 25,
wherein the receiving the charging profile from the Authentication, Authorization and Accounting server comprises receiving the charging profile via a Network Slice-Specific Authentication and Authorization function.

27. The method as claimed in claim 25,
wherein the charging profile comprises a set of charging characteristics, and the method comprises:
storing a set of charging characteristics; and
overriding use of the stored set of charging characteristics to use the charging characteristics comprised in the charging profile.

28. The method as claimed in claim 22,
wherein the event comprises at least one of: an authorization, a reauthorization, an authentication, a reauthentication, or a revocation.

29. The method as claimed in claim 22, comprising:
determining whether charging for Network Slice-Specific Authentication and Authorization is active in the network function,
wherein the signalling is performed when it is determined that charging for Network Slice-Specific Authentication and Authorization is active in the network function.

30. The method as claimed in claim 22,
wherein the charging data response comprises an indication of the event.

31. The method as claimed in claim 22,
wherein the charging data request indicates whether the event has been successful or unsuccessful.

32. A method for an Authentication, Authorization and Accounting function, the method comprising:
sending, to a network function, a charging profile for a network slice specific Authentication and Authorization process.

33. The method as claimed in claim 32,
wherein the charging profile indicates whether charging for Network Slice-Specific Authentication and Authorization is active or inactive in the network function.

34. An apparatus as claimed in claim 32,
wherein the charging profile is comprised in an Authentication, Authorization and Accounting protocol message in response to an Authentication, Authorization and Accounting request.

35. A method for a charging function, the method comprising means for:
receiving, from a network function, a charging data request, the charging data request comprising an identifier of a user equipment, an identifier of a network slice, and an indication of an event to which the charging data request relates, wherein the event is one of: an authorization, a reauthorization, an authentication, a reauthentication, and/or a revocation; and
signalling, to the network function, a charging data response.

36. The method as claimed in claim 35, comprising:
means for creating a charging record in response to receipt of the charging data request.

37. The method as claimed in claim 35,
wherein the charging data response comprises an indication of the event.

38. The method as claimed in claim 35,
wherein the charging data request indicates whether the event has been successful or unsuccessful.
